(19) United States
(12) Patent Application Publication
(10) Pub. No.: US 2024/0278673 A1
(43) Pub. Date: Aug. 22, 2024

(54) THERMAL MANAGEMENT OF AN ELECTRIC WORK VEHICLE

(71) Applicant: Perkins Engines Company Limited, Peterborough (GB)

(72) Inventor: Thomas L. TWIGGER, Spalding (GB)

(73) Assignee: Perkins Engines Company Limited, Peterborough (GB)

(21) Appl. No.: 18/570,517

(22) PCT Filed: Jun. 17, 2022
(86) PCT No.: PCT/EP2022/025282

§ 371 Date: Dec. 14, 2023

(30) Foreign Application Priority Data
Jun. 25, 2021 (GB) 2109201.0

(51) Int. Cl. B60L 53/62; B60H 1/00; H01M 10/44; H02J 7/00

(52) U.S. Cl. CPC B60L 53/62; H01M 10/443; H02J 7/0071; B60H 1/00278; B60L 2200/40; H01M 2220/20; H02J 2310/48

(57) ABSTRACT

A method of priority management of an electric work vehicle while the electric work vehicle is connected to a charging module. A duration of immobilization, a target temperature, a target state of charge, a minimum rise duration and a minimum charge duration are used to determine a charging start time and a heat exchange start time based on a time priority decision. The time priority decision is made such that the actual temperature of the first fluid is between the threshold temperature and the target temperature at the anticipated fluid usage time; an actual state of charge is between the threshold state of charge and the target state of charge at the anticipated start time; and an actual charge speed is below a threshold charge speed.

### FIELD OF THE DISCLOSURE

The disclosure relates to the field of electric work vehicles.

### BACKGROUND

Work vehicles contain fluids in various components of the vehicles, such as hydraulic oil and coolant loops for the heating, ventilation and air conditioning (HVAC). Management of the temperature of these fluids is key to the efficient operation of the work vehicle. For example, cold and viscous hydraulic fluid may result in parasitic losses.

In order for a work vehicle to be ready for an operator to use, it is necessary for the vehicle to have sufficient fuel and it is preferable for the fluids to be close to their optimum working temperatures. It is known to carry out thermal management of the fluids prior to the work vehicle starting work. For a diesel powered machine, this thermal management typically requires the operator to turn on the work vehicle and run the engine for a period of time to warm the fluids via heat rejection from the diesel engine. During the warm up period of time the operator is generally on site but unable to work, and the running engine is using fuel only for the purpose of generating heat.

Preparing an electric work vehicle to be ready for an operator to use involves charging the electric work vehicle, which is likely to be a more time consuming process than filling a diesel fuel tank. There is likely to be a finite length of time available in which to charge the battery before the electric work vehicle is required for use. In addition, the speed at which the battery is charged and the timing of the charge can affect the health of the battery. It is also preferable for fluids in the electric work vehicle to be heated prior to use of the electric work vehicle, similarly to fluids in diesel powered work vehicles. Optimal fluid temperatures allow more reliable operation of components such as batteries, motors, inverters, DC-DC converters and chargers. However, electric work vehicles do not have the same native heat rejection of an internal combustion engine, and so actively heat the fluids via dedicated heating elements.

Typically, electric work vehicles will be charged while the operator is absent so that an operator will return to a charged, but cold, electric work vehicle. Before starting work the operator will begin heating the fluids and wait for the fluid temperatures to be close to their optimum working temperatures. The heating process may draw power from the battery of the electric work vehicle. Similarly to diesel powered vehicles, heating the fluids in this way wastes time in which the operator could be working and is an inefficient use of vehicle power. Pre-heating the fluids before the operator returns to the vehicle would be preferable to save time, but risks power and time being diverted from charging the battery. This may result in a battery that is not sufficiently charged for use, or may result in degradation of the battery health if charging is carried out at unsuitable speeds or temperatures.

### SUMMARY OF THE DISCLOSURE

Against this background there is provided a method of priority management of an electric work vehicle while the electric work vehicle is connected to a charging module. The method comprises determining an anticipated start time of the electric work vehicle at which the electric vehicle is expected to be disconnected from the charging module, wherein the anticipated start time is used to determine a duration of immobilization. The method further comprises determining an anticipated fluid usage time at which a first fluid of the electric work vehicle is expected to be used. The method further comprises determining a target temperature for a first fluid at the anticipated fluid usage time. The method further comprises determining a target state of charge for a battery at the anticipated start time. The method further comprises determining a minimum rise duration for an actual temperature of the first fluid to be adjusted from an initial temperature to a threshold temperature. The method further comprises determining a minimum charge duration for the battery to be charged at a first charge speed from an initial state of charge to a threshold state of charge. The method further comprises using the duration of immobilization, the target temperature, the target state of charge, the minimum rise duration and the minimum charge duration to determine a charging start time and a heat exchange start time based on a time priority decision. The method further comprises initiating charging the battery at first charge speed at the charging start time and initiating adjustment of the first temperature of the first fluid at the heat exchange start time. The time priority decision is made such that the actual temperature of the first fluid is between the threshold temperature and the target temperature at the anticipated fluid usage time, an actual state of charge is between the threshold state of charge and the target state of charge at the anticipated start time, and an actual charge speed is below a threshold charge speed.

There is also provided an electric work vehicle comprising a priority controller configured to carry out thermal management of the electric work vehicle prior to use of the electric work vehicle, while the electric work vehicle is connected to a charging module. The priority controller is configured to determine an anticipated start time of the electric work vehicle at which the electric vehicle is expected to be disconnected from the charging module, wherein the anticipated start time is used to determine a duration of immobilization. The priority controller is further configured to determine an anticipated fluid usage time at which a first fluid of the electric work vehicle is expected to be used. The priority controller is further configured to determine a target temperature for a first fluid at the anticipated fluid usage time. The priority controller is further configured to determine a target state of charge for a battery at the anticipated start time. The priority controller is further configured to determine a minimum rise duration for an actual temperature of the first fluid to be adjusted from an initial temperature to a threshold temperature. The priority controller is further configured to determine a minimum charge duration for the battery to be charged at a first charge speed from an initial state of charge to a threshold state of charge. The priority controller is further configured to use the duration of immobilization, the target temperature, the target state of charge, the minimum rise duration and the minimum charge duration to determine a charging start time and a heat exchange start time based on a time priority decision. The priority controller is further configured to initiate charging the battery at first charge speed at the charging start time and initiating adjustment of the first temperature of the first fluid at the heat exchange start time. The time priority decision is made such that the actual temperature of the first fluid is between the threshold temperature and the target temperature at the anticipated fluid usage time, an actual state of charge is between the threshold state of charge and the target state of charge at the anticipated start time, and an actual charge speed is below a threshold charge speed.

In this way the duration of immobilization may be used to prepare the electric work vehicle to be ready to use. A time priority decision may be made to ensure that the battery is sufficiently charged at the anticipated start time and the first fluid is sufficiently warm at the anticipated fluid usage time.

### BRIEF DESCRIPTION OF THE DRAWINGS

A specific embodiment of the disclosure will now be described, by way of example only, with reference to the accompanying drawings in which:

FIG. 1 shows a flowchart illustrating a method of priority management of an electric work vehicle according to an embodiment of the present disclosure.

FIG. 2 shows a flowchart illustrating a method of priority management of an electric work vehicle according to an embodiment of the present disclosure.

### DETAILED DESCRIPTION

According to an embodiment of the disclosure, a method is provided of priority management of an electric work vehicle while the electric work vehicle is connected to a charging module. An anticipated start time of the electric work vehicle is determined, at which the electric vehicle is expected to be disconnected from the charging module. The anticipated start time may be a time at which a user of the electric work vehicle is expected to return to work and use the electric work vehicle. The anticipated start time is used to determine a duration of immobilization of the electric work vehicle. The duration of immobilization may be the time available to prepare the electric work vehicle to be ready for use. A time priority decision may be made as to how best to use the duration of immobilization such that the electric work vehicle is ready to be used at the anticipated start time. In order to be ready to be used, the electric work vehicle should be sufficiently charged and its fluid should be close to an appropriate temperature. In order to achieve this, at least one of a charging time, heating time and charging speed may be adjusted.

The electric work vehicle may comprise a battery, for which a target state of charge at the anticipated start time is be determined. The target state of charge may be a desired state of charge at the anticipated start time, and may be higher than a threshold state of charge. The threshold state of charge may be the state of charge above which the electric work vehicle may be used. A minimum charge duration is determined, wherein the minimum charge duration is the time that would be taken for the battery to be charged at a first charge speed from an initial state of charge to the threshold state of charge. An anticipated fluid usage time is determined, at which a first fluid of the electric work vehicle is expected to be used, and a target temperature for the first fluid at the anticipated fluid usage time is determined. The target temperature may be a desired temperature at the anticipated start time, and may be different from a threshold temperature at which the first fluid may be used. A minimum rise duration is determined, for an actual temperature of the first fluid to be adjusted from the initial temperature to a threshold temperature.

The duration of immobilization, the target temperature, the target state of charge, the minimum rise duration and the minimum charge duration are then used to determine a charging start time and a heat exchange start time based on a time priority decision. Charging the battery is initiated at first charge speed at the charging start time and adjustment of the first temperature of the first fluid is initiated at the heat exchange start time. The time priority decision is made such that the actual temperature of the first fluid is between the threshold temperature and the target temperature at the anticipated fluid usage time, the actual state of charge is between the threshold state of charge and the target state of charge at the anticipated start time, and an actual charge speed is below a threshold charge speed.

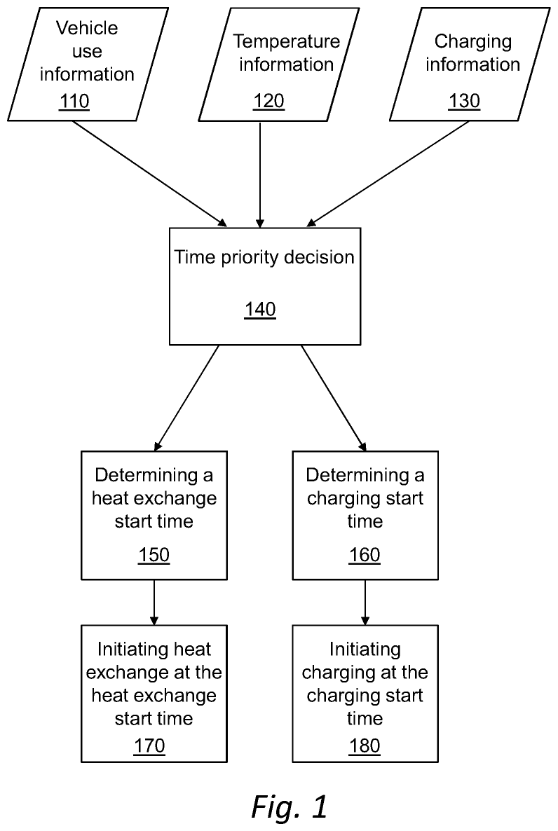

FIG. 1 illustrates a method of priority management of an electric work vehicle according to an embodiment of the present disclosure. Vehicle use information 110, temperature information 120 and charging information 130 may be used to make the time priority decision 140. The time priority decision 140 determines a heat exchange start time at step 150 and determines a charging start time at step 160. Heat exchange is initiated at the heat exchange start time (step 170) and charging is initiated at the charging start time (step 180).

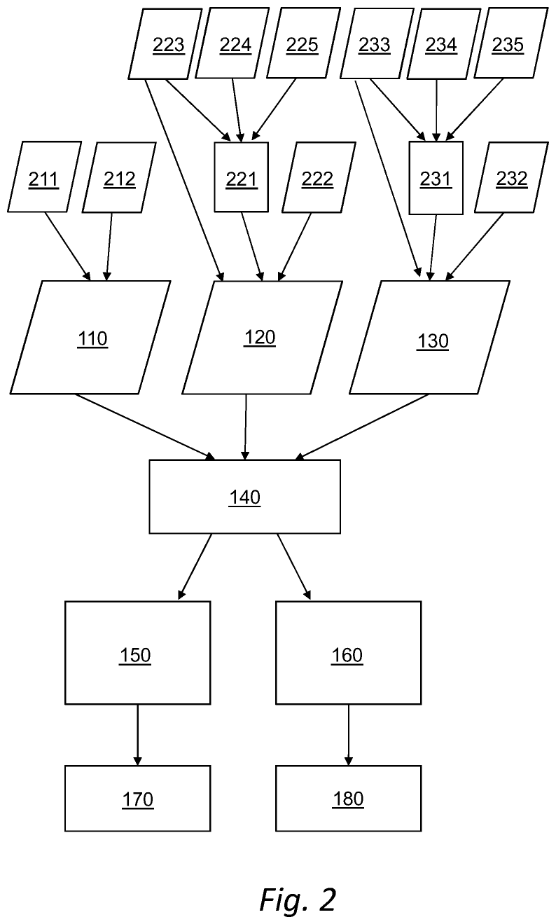

With reference to FIG. 2, the vehicle use information 110 may comprise the anticipated start time 211 and the anticipated fluid usage time 212. The temperature information 120 may comprise the minimum rise duration 221, the target temperature 222 and the threshold temperature 223. The minimum rise duration 221 may be determined using the threshold temperature 223, the initial temperature 224 and a first heat exchange speed 225. The charging information 130 may comprise the minimum charge duration 231, the target state of charge 232 and the threshold state of charge 233. The minimum charge duration may be determined using the threshold state of charge 233, the initial state of charge 234 and the first charge speed 235.

In an embodiment, a rise duration for the first fluid may be determined based on the total heat input available, an estimate of heat loss, properties of the first fluid and a first temperature to which the fluid will be heated. The total heat input may be calculated from properties of a heater comprising at least one of heater power, heater efficiency and heater power management limit. The heat loss may be estimated from a temperature of the first fluid and an ambient temperature. The properties of the first fluid may comprise a first fluid volume and a first fluid specific heat capacity.

In an embodiment, the heater may draw power directly from the charging module (rather than from the battery). The heater power management limit may be determined based on a state of charge of the battery, a current limit of the battery and a charging module power supply capacity.

In another embodiment, the method of priority management may further comprise a power priority decision. In the event that the heater and charging module are drawing power from the same supply, a power priority decision may be made such that the actual temperature of the first fluid is between the threshold temperature and the target temperature at the anticipated fluid usage time, the actual state of charge is between the threshold state of charge and the target state of charge at the anticipated start time, and an actual charge speed is below a threshold charge speed.

The embodiments described above make a time priority decision relating to heat exchange for a first fluid, and charging of the battery. The time priority decision may be made relating to heat exchange for a plurality of fluids and charging of the battery. There may be a plurality of anticipated fluid usage times for the plurality of fluids. For example, an electric work vehicle may comprise one or more of hydraulic oil, a battery coolant loop, a heating, ventilation and air conditioning (HVAC) coolant loop and a motor or inverter coolant loop. The time priority decision may be made such that for each of the plurality of fluids, an actual temperature of the fluid is between the threshold temperature and the target temperature at the anticipated fluid usage time. The time priority decision may further be made such that the actual state of charge is between the threshold state of charge and the target state of charge at the anticipated start time, and an actual charge speed is below a threshold charge speed.

In an event that a power priority decision is made, the power priority decision may be made relating to heat exchange for the plurality of fluids and charging of the battery. The power priority decision may be made such that for each of the plurality of fluids, an actual temperature of the fluid is between the threshold temperature and the target temperature at the anticipated fluid usage time. The power priority decision may further be made such that the actual state of charge is between the threshold state of charge and the target state of charge at the anticipated start time, and an actual charge speed is below a threshold charge speed.

In an embodiment, heat exchange for the plurality of fluids may be carried out via a primary coolant circuit. The primary coolant circuit may comprise a plurality of secondary coolant circuits connected to the primary coolant circuit via valves. A single heater may be used. In another embodiment, heat exchange for the plurality of fluids may be carried out via a plurality of separate coolant circuits and/or a plurality of heaters. The coolant circuits may be used to increase or decrease temperature of the fluids.

In an embodiment, a plurality of rise durations may be determined for each of the plurality of fluids. The longest of the plurality of rise durations may be used in at least one of the time priority decision and the power priority decision to determine a primary heat exchange start time. The primary heat exchange start time and the plurality of rise durations may be used to determine a plurality of secondary heat exchange start times for each of the other fluids. Heating of the fluid corresponding to the longest of the plurality of rise durations may be initiated at the primary heat exchange start time. Heating of each of the other fluids may be initiated at each of the secondary heat exchange start times. In an event that heat exchange for the plurality of fluids is carried out via a primary coolant circuit comprising secondary coolant circuits, each fluid may be heated by a secondary coolant circuit wherein the coolant secondary circuit is connected to the primary coolant circuit via one or more valves at the secondary heat exchange start time corresponding to that fluid.

In an event that heat exchange for the plurality of fluids may be carried out via a plurality of separate coolant circuits and/or a plurality of heaters, a further power priority decision may be made to determine how many fluids may be heated simultaneously. In an event that not all of the plurality of fluids may be heated simultaneously, one or more of the plurality of fluids may reach a final temperature that is between the threshold temperature and the target temperature before the anticipated fluid usage time. The actual temperature may be maintained at the final temperature until the anticipated fluid usage time. Heat loss to ambient after the fluid has reached the final temperature may be taken into account when determining the threshold temperature.

In an embodiment the plurality of fluids may be assigned a plurality of ranks. At least one of the time priority decision and the power priority decision may be based on the plurality of ranks, such that heat exchange for a fluid with a higher rank is prioritised over heat exchange for a fluid with a lower rank.

The threshold state of charge may comprise the state of charge of the battery required for the electric work vehicle to be used for the next work session. The threshold state of charge may comprise the state of charge of the battery required for the electric work vehicle to be used for the next work session and to return to a charging module. The threshold state of charge may be a predetermined value or may be determined based on previous usage data for the electric work vehicle.

The anticipated fluid usage times may comprise a specific time, or may comprise an order compared to other anticipated fluid usage times, the charging start time or the anticipated return to work time. For example, a fluid may be warmed before the charging start time, or before the anticipated return to work time.

In an embodiment, a first fluid may be warmed in order to warm the battery prior to charging. In this embodiment, the anticipated fluid usage time of the first fluid may be prior to or at the charging start time. There may be further fluids with anticipated fluid usage times after the charging start time. The heat exchange start times for the first fluid and further fluids may be determined by the time priority decision.

In an embodiment, a plurality of fluids may have different anticipated fluid usage times. The plurality of fluids may be warmed via a primary coolant circuit or via a plurality of coolant circuits or a plurality of heaters. The one or more coolant circuits or heaters may initiate heat exchange for a first fluid at a first heat exchange start time and stop heat exchange after a first anticipated fluid usage time for a first fluid. The one or more coolant circuits or heaters may restart heat exchange for a second fluid at a second heat exchange start time and stop heat exchange after a second anticipated fluid usage time for a second fluid. In another embodiment, the one or more coolant circuits or heaters may maintain the temperature of the first fluid after the first anticipated fluid usage time, at the temperature value reached at the first anticipated fluid usage time. In another embodiment, the second heat exchange start time may be before the first anticipated fluid usage time, such that heat exchange for the first fluid and heat exchange for the second fluid overlap.

1. A method of priority management of an electric work vehicle while the electric work vehicle is connected to a charging module, wherein the method comprises:
determining:
an anticipated start time of the electric work vehicle at which the electric vehicle is expected to be disconnected from the charging module, wherein the anticipated start time is used to determine a duration of immobilization;
an anticipated fluid usage time at which a first fluid of the electric work vehicle is expected to be used;
a target temperature for a first fluid at the anticipated fluid usage time;
a target state of charge for a battery at the anticipated start time;
a minimum rise duration for an actual temperature of the first fluid to be adjusted from an initial temperature to a threshold temperature; and
a minimum charge duration for the battery to be charged at a first charge speed from an initial state of charge to a threshold state of charge;
using the duration of immobilization, the target temperature, the target state of charge, the minimum rise duration and the minimum charge duration to determine a charging start time and a heat exchange start time based on a time priority decision; and
initiating charging the battery at first charge speed at the charging start time and initiating adjustment of the first temperature of the first fluid at the heat exchange start time;
wherein the time priority decision is made such that:
the actual temperature of the first fluid is between the threshold temperature and the target temperature at the anticipated fluid usage time;
an actual state of charge is between the threshold state of charge and the target state of charge at the anticipated start time; and
an actual charge speed is below a threshold charge speed.

2. The method of claim 1 wherein the threshold state of charge is a charge percentage of the target state of charge value.

3. The method of claim 1 wherein the threshold temperature is a temperature percentage of the first target temperature.

4. The method of claim 1 wherein the threshold charge speed is determined based on the duration of immobilization.

5. The method of claim 1 wherein minimum rise duration is selected from a plurality of rise durations for a plurality of fluids of the electric work vehicle to reach a plurality of threshold temperatures.

6. The method of claim 5 wherein the plurality of fluids are assigned a plurality of ranks and wherein the minimum rise duration for the first fluid is selected based on a first rank.

7. The method of claim 1 wherein the first rise duration for the first fluid is determined based on at least one of;
a first initial temperature of the first fluid;
the first target temperature;
a first beat input value;
a first volume of the first fluid; and
a first fluid specific heat capacity of the first fluid.

8. The method of claim 7 wherein the first rise duration for the first fluid is further determined based on a first heat loss estimate calculated from an ambient temperature.

9. The method of claim 7 wherein the first heat input value is determined based on:
a first heater power; and
a first heater efficiency.

10. The method of claim 1 further comprising:
determining:
a first power required to adjust the first fluid to the first target temperature;
a charge power required for a battery of the electric work vehicle to reach a target state of charge value; and
an available power;
making a power priority decision such that:
the actual temperature of the first fluid is between the threshold temperature and the target temperature at the anticipated fluid usage time;
an actual state of charge is between the threshold state of charge and the target state of charge at the anticipated start time; and
an actual charge speed is below a threshold charge.

11. The method of claim 2 further comprising adjusting a plurality of temperatures of the plurality of fluids via a single coolant circuit.

12. The method of claim 2 further comprising adjusting a plurality of temperatures of the plurality of fluids via a plurality of coolant circuits.

13. The method of claim 1 wherein the first fluid usage time is prior to or at the charging start time.

14. An electric work vehicle comprising a priority controller configured to carry out thermal management of the electric work vehicle prior to use of the electric work vehicle, while the electric work vehicle is connected to a charging module, wherein the priority controller is configured to:
determine:
an anticipated start time of the electric work vehicle at which the electric vehicle is expected to be disconnected from the charging module, wherein the anticipated start time is used to determine a duration of immobilization;
an anticipated fluid usage time at which a first fluid of the electric work vehicle is expected to be used;
a target temperature for a first fluid at the anticipated fluid usage time;
a target state of charge for a battery at the anticipated start time;
a minimum rise duration for an actual temperature of the first fluid to be adjusted from an initial temperature to a threshold temperature; and
a minimum charge duration for the battery to be charged at a first charge speed from an initial state of charge to a threshold state of charge;
use the duration of immobilization, the target temperature, the target state of charge, the minimum rise duration and the minimum charge duration to determine a charging start time and a heat exchange start time based on a time priority decision; and
initiate charging the battery at first charge speed at the charging start time and initiating adjustment of the first temperature of the first fluid at the heat exchange start time;
wherein the time priority decision is made such that:
the actual temperature of the first fluid is between the threshold temperature and the target temperature at the anticipated fluid usage time;
an actual state of charge is between the threshold state of charge and the target state of charge at the anticipated start time; and
an actual charge speed is below a threshold charge speed.
